(19) United States
(12) Patent Application Publication
(10) Pub. No.: US 2012/0215800 A1
(43) Pub. Date: Aug. 23, 2012

(54) TIME-AWARD READING CONTENT

(75) Inventor: Andrew Yonemoto, San Jose, CA (US)

(73) Assignee: SONY CORPORATION, Tokyo (JP)

(21) Appl. No.: 13/285,553

(22) Filed: Oct. 31, 2011

Related U.S. Application Data
(60) Provisional application No. 61/445,873, filed on Feb. 23, 2011.

(51) Int. Cl. G06F 17/30

(52) U.S. Cl. 707/758; 707/E17.001

(57) ABSTRACT

Embodiments generally relate to time-based reading content. In one embodiment, a method includes opening a content file, wherein the content file contains time-dependent content items. The method also includes determining the time of day, determining which time-dependent content items to display based on the time of day, and displaying the time-dependent content items based on the time of day.

### CROSS REFERENCE TO RELATED APPLICATIONS

This application claims priority from U.S. Provisional Patent Application Ser. No. 61/445,873, entitled TIME-AWARD READING CONTENTS, filed on Feb. 23, 2011, which is hereby incorporated by reference as if set forth in full in this application for all purposes.

### BACKGROUND

Portable electronic devices such as e-readers display text on a screen. Such e-readers enable users to read digital books and digital periodicals. E-readers have screens that provide high-quality readability, especially in bright sunlight. A user may download digital books and digital periodicals onto an e-reader. Such digital books and digital periodicals are electronic versions of paper books and paper periodicals, in that the presented content material is the same.

### SUMMARY

Embodiments generally relate to time-based reading content. In one embodiment, a method includes opening a content file, wherein the content file contains time-dependent content items. The method also includes determining the time of day, determining which time-dependent content items to display based on the time of day, and displaying the time-dependent content items based on the time of day.

### BRIEF DESCRIPTION OF THE DRAWINGS

FIG. 1 illustrates a block diagram of an example environment, which may be used to implement the embodiments described herein.

FIG. 2 illustrates a block diagram of an example computer system, which may be used to implement the embodiments described herein.

FIG. 3 illustrates an example simplified flow diagram for displaying time-dependent content, according to one embodiment.

FIG. 4 illustrates an example diagram for displaying time-dependent content, according to one embodiment.

FIG. 5 illustrates an example simplified flow diagram for generating time-dependent content, according to one embodiment.

### DETAILED DESCRIPTION

Embodiments described herein enable, facilitate, and manage time-based content material. Embodiments enable an author and/or publisher to automatically change content material in an end-user device, such as an e-reader, based on the time of day. After content material is downloaded onto the end-user device, the end-user device automatically displays the content material based on the time of day, which provides time-based relevance to the content material. Such time-relevant content may be more useful to end users when displayed than static content that does not change.

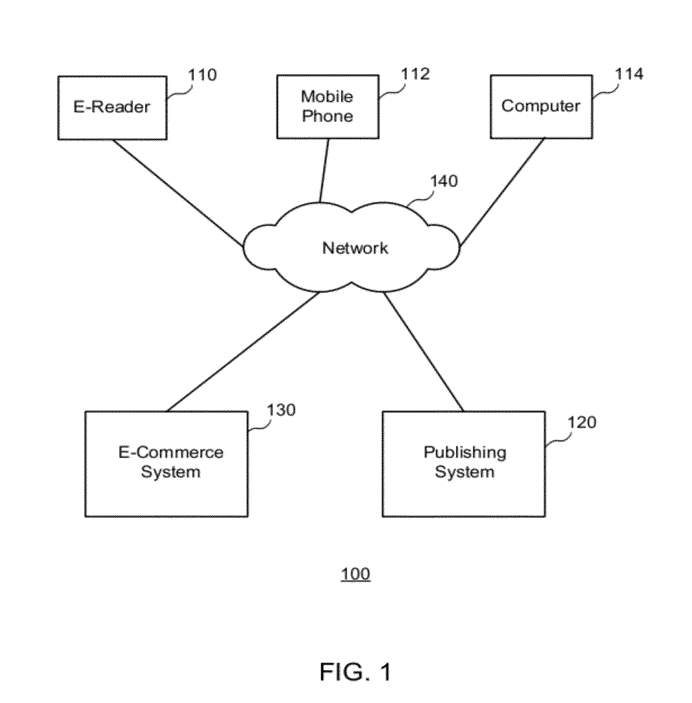

FIG. 1 is a block diagram of an example environment 100, which may be used to implement the embodiments described herein. In one embodiment, environment 100 may include end-user devices 110, 112, 114, etc. End-user devices may include portable electronic devices such as an e-reader 110, a mobile phone 112, etc. In various embodiments, an e-reader, also called an e-book, is a portable electronic device that functions primarily for the purpose of reading digital books and periodicals. End-user devices 110, 112, and 114, may also include a computer 114, which may be a tablet, notebook computer, laptop computer, desktop computer, etc. Environment 100 may also include a publishing system 120, an e-commerce system 130, etc. These elements communicate with each other over a network 140. In various embodiments, e-commerce system 130 may be any on-demand database system such as a cloud service provider, which provides resources to partners (e.g., publishers) and/or end-customers as a service. Such resources may include the ability to sell or purchase products (such as digital books and digital periodicals, etc.) and services (e.g., subscriptions).

In various embodiments, end-user devices 110, 112, 114, etc., may store digital books and digital periodicals, which may be downloaded from publishing system 120 and/or via e-commerce system 130 via network 140.

For ease of illustration, FIG. 1 shows one block for each of e-reader 110, mobile phone 112, computer 114, publishing system 120, and e-commerce system 130. Each of these blocks 110, 112, 114, 120, and 130 may represent multiple e-readers, mobile phones, computers, publishing systems, and e-commerce systems.

Although embodiments disclosed herein are described in the context of e-readers and publishing systems, the embodiments may apply to any end-user devices and publishing systems including those not shown in FIG. 1. For example, publishing systems may include but are not limited to e-magazines, travel related e-magazines, websites, etc.

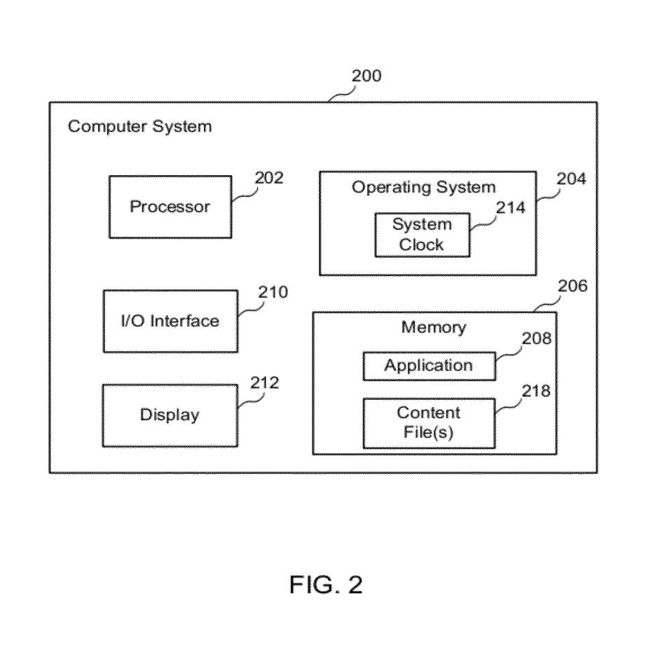

FIG. 2 is a block diagram of an example computer system 200, which may be used to implement the embodiments described herein. In one embodiment, computer system 200 may include a processor 202, an operating system 204, a memory 206, an application 208, an input/output (I/O) interface 210, and a display 212. Operating system 204 includes a system clock 214. I/O interface 210 enables a user to input information into computer system 200 (e.g., via a keyboard, touch screen, microphone, etc.), and enable information to be displayed to the user (e.g., via display 212). As shown, display 212 may be integrated into computer system 200. In other embodiments, display 212 may be external to computer system 200. These component blocks of computer system 200 may be implemented by one or more processors or any combination of hardware devices, as well as any combination of hardware, software, firmware, etc.

In various embodiments, memory 206 may also store time-dependent content in one or more content files 218. As described in more detail below, each content file stores time-dependent content items that are displayed to a user based on the time of day.

Application 208 may be stored on memory 206 or on any other suitable storage location or computer-readable medium. Application 208 provides instructions that enable processor 202 to perform the functions described herein. As described in more detail below, application 208 may represent multiple applications for performing various functions described herein. For example, in one embodiment, application 208 may represent a viewing application for displaying time-dependent content, where application 208 resides on an end user device. In another embodiment, application 208 may represent a publishing application for generating time-dependent content, where application 208 resides on a publishing system.

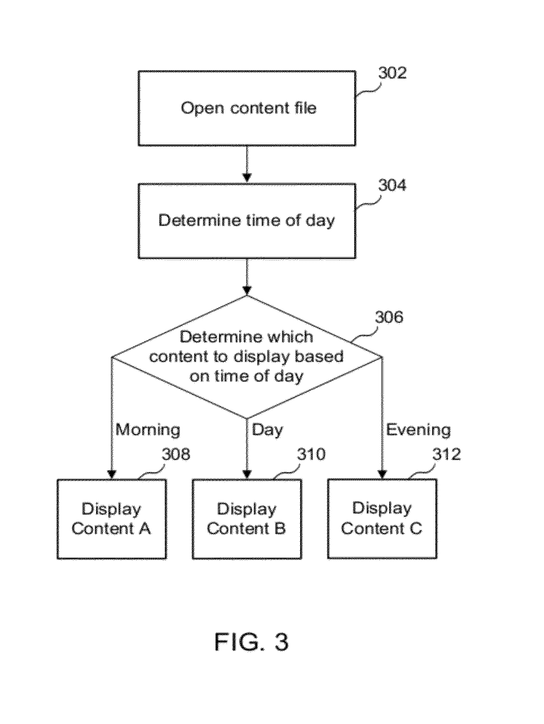

FIG. 3 illustrates an example simplified flow diagram for displaying time-dependent content, according to one embodiment. Referring to FIGS. 1, 2, and 3, the method is initiated in block 302, where application 208 opens content file 218, where content file 218 contains time-dependent content items. In an embodiment, application 208 functions as a viewer application and resides on an end user device (e.g., e-reader 110, mobile phone 112, computer 114, etc.). As indicated above, content file 218 includes time-dependent content items of reading material (e.g., for a given article, e-book, etc.). In one embodiment, a content file 218 may contain all content for a particular unit of reading material (e.g., an article, an e-book, etc.). In some embodiments, there may be multiple content files 218 related to the same unit of reading material, where different portions of the content (e.g., different content items) for a particular unit of reading material are contained in different content files 218. For example, for a given e-book, there may be a content file 218 for each chapter of the e-book. For ease of illustration, content file 218 may represent one or more content files associated with a given unit of reading material (e.g., an article, an e-book, etc.). As such, application 208 may retrieve one or more content files 218 associated with a particular unit of reading material, and process all such content files 218 accordingly.

In block 304, application 208 determines the time of day. In one embodiment, application 208 may retrieve the time of day from system clock 214 or any suitable clock running on the computer system 200 or accessible by computer system 200.

In block 306, application 208 determines which time-dependent content items to display based on the time of day. In one embodiment, application 208 determines time constraints associated with each time-dependent content item from content file 218. In one embodiment, a time constraint may be a time period, where a given time period may include any range of predetermined times. Application 208 then compares the time of day against the time constraints associated with each time-dependent content item from content file 218. In one embodiment, there may be multiple time constraints, where each time constraint is associated with one or more different time-dependent content items from content file 218. For example, in one embodiment, a first time constraint may include morning hours, a second time constraint may include day hours, and a third time constraint may include evening hours, etc. As described in more detail below, each time constraint may be associated with a particular range of predetermined times. For example, morning hours may range from 6:00 AM-8:59 AM, day hours may include business hours, e.g., 9:00 AM-4:59 PM, and evening hours range from 5:00 PM-5:59 AM. As described in more detail below, other ranges of times are possible.

Application 208 determines which content to display by identifying a match between the time of day and the time constraints, where application 208 displays the time-dependent content items (e.g., labeled “Content A,” “Content B,” and “Content C” in FIG. 3) associated with the time constraints that match the time of day.

Application 208 then displays the time-dependent content items based on the time of day. For example, if application 208 determines that the time of day is in the morning hours, application 208 displays time-dependent content items (e.g., Content A) that are associated with the morning hours, in block 308. In one embodiment, application 208 by default does not display time-dependent content items (e.g., Content B and Content C) that are not associated with the time constraints that match the time of day (e.g., morning hours). In one embodiment, application 208 may provide controls to allow a user to view some or all content regardless of the time of day.

If application 208 determines that the time of day is in the day hours, application 208 displays time-dependent content items (e.g., Content B) that are associated with the day hours, in block 310. In one embodiment, application 208 by default does not display time-dependent content items (e.g., Content A and Content C) that are not associated with the day hours.

If application 208 determines that the time of day is in the evening hours, application 208 displays time-dependent content items (e.g., Content C) that are associated with the evening hours, in block 312. In one embodiment, application 208 by default does not display time-dependent content items (e.g., Content A and Content B) that are not associated with the evening hours.

These time ranges are only examples, and the particular start and end of a particular range of time will vary, depending on the particular implementation. In various embodiments, the author or publisher determines the time constraints, including the start and end of a particular range of time. For example, time constraints may be defined by time periods that are substantially in half-hour increments (e.g., 12:00 PM-12:29 PM, 12:30 PM-1:00 PM, etc.), hour increments (e.g., 12:00 PM-12:59 PM, 1:00 PM-1:59 PM, etc.), or any other time periods. Other example time periods may include 12:00 AM-5:59 AM, 6:00 AM-11:59 AM, 12:00 PM-5:59 PM, 6:00 PM-11:59 PM, or any other time periods (e.g., 12:00 AM-11:59 AM, 12:00 PM-11:59 PM, etc.). The precise start and end of each range (e.g., 12:00 PM-12:29 PM, 12:01 PM-12:30 PM, etc.) may vary, and will depend on the specific implementation. In some embodiments, the time periods may include particular days or groups of days (e.g., weekend days).

In an example implementation, an online travel guide may include restaurant recommendations and restaurant reviews. Application 208 may display different content based on when a given user is reading the travel guide. For instance, during earlier morning hours, the viewer application may display breakfast or brunch recommendations. During later morning hours, the application 208 may display lunch recommendations. During afternoon hours, the application 208 may display dinner recommendations. Embodiments are also useful for eliminating information for stores when not open. For example, if store is closed Tuesday, particular content will not show up on a list of recommendations when the user is viewing the content on Tuesday. If a restaurant is not open until evening, the content will not be displayed (or presented to the user) during the day.

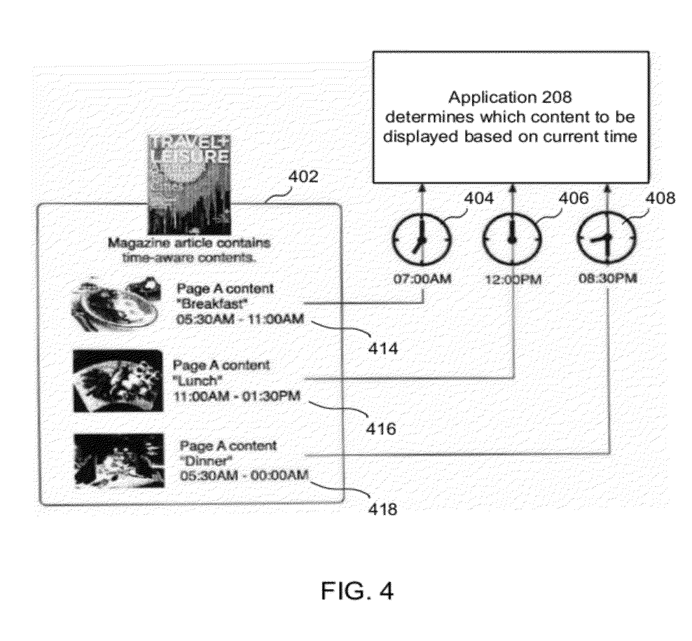

FIG. 4 illustrates an example diagram for displaying time-dependent content, according to one embodiment. As indicated above, one or more content files 218 may be associated with a particular unit of reading material (e.g., an article, an e-book, etc.), where different time-dependent content items (e.g., labeled “time-aware contents”) for different times of day are displayed depending on the time of day. As shown in FIG. 4, content associated with a magazine article 402 is available for display.

Application 208 (labeled “viewer application software”) determines which time-dependent content items to display based on the current time. In one embodiment, application 208 continually determines the time of day. When the time of day falls within a new time range, application 208 automatically changes/switches the content based on the identified time of day. For example, if the current time is 7:00 AM 404, application 208 displays Page A Content for breakfast, because 7:00 AM 404 falls within or matches the 5:30 AM-11:00 AM time constraint 414. If the current time is 12:00 PM 406, application 208 displays Page A Content for lunch, because 12:00 PM 406 falls within or matches the 11:00 AM-1:30 PM time constraint 416. If the current time is 6:30 PM 408, application 208 displays Page A Content for dinner, because 6:30 PM 408 falls within or matches the 5:30 PM-12:00 AM (labeled 5:30 PM-00:00 AM) time constraint 418.

In one embodiment, application 208 enables merchant authors/publishers to control when content is displayed. For example, in one embodiment, a merchant may control which content is displayed during particular times. As a result, application 208 may display different content during the morning, afternoon, and evening, as described in an example above.

In one embodiment, the time constraints may include time periods that the merchant is available. As such, in one embodiment, application 208 may display content based on the merchant's availability. For example, if the merchant is not open during particular times of the day or during a particular day, application 208 may filter the content such that particular content (e.g., promotions, recommendations, etc.) are selectively shown during particular time periods.

In one embodiment, if the merchant author/publisher does not want content to be filtered out by above mechanisms, the merchant author/publisher may set a preference to display content that is outside of their business hours (e.g., with a message such as “Open to accept reservations”).

In one embodiment, application 208 may enable the end user to set time constraints to control which time-dependent content items the end user wants to see (e.g., content associated with particular time periods during the day, particular days, particular weeks, etc.).

Embodiments disclosed herein enable merchant authors/publishers to change any content (e.g., their business names, menu items, etc.) based on the time of day. For example, a Japanese restaurant may advertise as a ramen restaurant based on the time of day. Embodiments may enable a merchant author/publisher to bypass time-constraint filtering by setting content preferences.

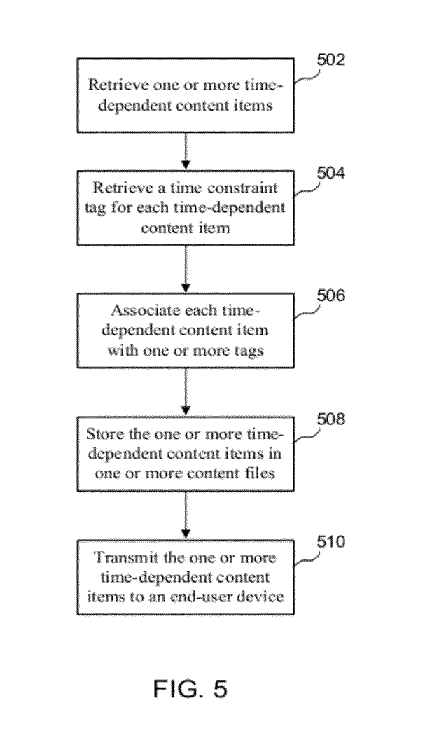

FIG. 5 illustrates an example simplified flow diagram for generating time-dependent content, according to one embodiment. Referring to FIGS. 1, 2, and 5, the method is initiated in block 502, where application 208 retrieves one or more time-dependent content items. In an embodiment, application 208 functions as a publishing application and resides in a publishing system (e.g., publishing system 120). In one embodiment, application 208 retrieves the content material from a user (e.g., author, publisher, etc.). The user may input the content via any suitable input device. In one embodiment, application 208 may be a plug-in to other publishing software. In one embodiment, application 208 may retrieve content that has been previously stored in an applicable memory of the publishing system.

In block 504, application 208 retrieves a time-constraint tag for each time-dependent content item. In one embodiment, the user (e.g., author, publisher, etc.) may designate a particular time constraint (e.g., 6:00 AM-8:59 AM) for each time-constraint tag, where each tag may be associated with a different time period. For example, a given tag may be associated with a particular of the day (e.g., 12:00 PM-12:59 PM, 1:00 PM-4:59 PM, etc.). These time periods are merely examples, and the actual time periods will depend on the particular implementation. The user may also tag each time-dependent content item with one or more time-constraint tags.

In block 506, application 208 associates each time-dependent content item with one or more tags. As a result, in one embodiment, each time-dependent content item is associated via one or more tags with one or more time periods.

In block 508, application 208 stores the one or more time-dependent content items in one or more content files. In one embodiment, if there are multiple time-dependent content items, application 208 may combine the time-dependent content items into a single content file 218. In one embodiment, application 208 may store different time-dependent content items related to one unit of reading material (e.g., article, e-book, etc.) in different content files 218. The one or more content files 218 may be stored in any suitable storage location (e.g., memory 206).

In block 510, application 208 transmits the one or more time-dependent content items to an end-user device (e.g., e-reader 110, mobile phone 112, computer 114, etc.).

Embodiments described herein have various applications. For example, embodiments may be implemented to provide an electronic textbook having time-dependent content. Such time-dependent content may include content for a particular class period. For example, such content may include lecture material, quiz material, test material, etc. In one embodiment, after a predetermined time (e.g., after a class period where quiz material is displayed), application 208 may enable end users to access content (e.g., quiz material for review). In another example, application 208 may display particular content at different times in order to encourage an end user to read different content along predetermined timelines.

Embodiments described herein are also compatible with end user devices that do not recognize time-constraint tags. Such end user devices that do not recognize time-constraint tags ignore such tags and display all content.

Embodiments described herein may be applied to recipe management. For example, in a “Japanese” gourmet e-magazine, application 208 may display breakfast recipes (e.g., for rice, miso soup, pickles, etc.) when the e-magazine is opened in the morning. Application 208 may display recommendations for day (e.g., teriyaki chicken, sake, etc.) when the e-magazine is opened in the afternoon.

Embodiments described herein provide numerous benefits. For example, embodiments allow static content, which may be irrelevant at certain times, to become more relevant by being displayed at particular targeted times of day. As such, an end user may be attracted to continue reading if more relevant content is displayed.

Although the description has been described with respect to particular embodiments thereof, these particular embodiments are merely illustrative, and not restrictive.

Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A method comprising:
opening a content file, wherein the content file contains a plurality of time-dependent content items;
determining a time of day;
determining which time-dependent content items to display based on the time of day; and
displaying the time-dependent content items based on the time of day.

2. The method of claim 1, wherein the determining which time-dependent content items to display comprises determining time constraints associated with each time-dependent content item.

3. The method of claim 1, wherein the determining which time-dependent content items to display comprises determining time constraints associated with each time-dependent content item, and wherein a time constraint is a time period.

4. The method of claim 1, wherein the determining which time-dependent content items to display comprises determining time constraints associated with each time-dependent content item, wherein a time constraint is a time period, and wherein the time period includes a range of predetermined times.

5. The method of claim 1, wherein the determining which time-dependent content items to display comprises comparing the time of day against time constraints associated with each time-dependent content item.

6. The method of claim 1, wherein the determining which time-dependent content items to display comprises:
determining time constraints associated with each time-dependent content item; and
identifying a match between the time of day and the time constraints.

7. The method of claim 1, wherein the determining which time-dependent content items to display comprises:
determining time constraints associated with each time-dependent content item;
identifying a match between the time of day and the time constraints; and
displaying the time-dependent content items that are associated with the time constraints that match the time of day.

8. A computer-readable storage medium carrying one or more sequences of instructions thereon, the instructions when executed by a processor cause the processor to:
open a content file, wherein the content file contains a plurality of time-dependent content items;
determine a time of day;
determine which time-dependent content items to display based on the time of day; and
display the time-dependent content items based on the time of day.

9. The computer-readable storage medium of claim 8, wherein the instructions further cause the processor to determine time constraints associated with each time-dependent content item.

10. The computer-readable storage medium of claim 8, wherein the instructions further cause the processor to determine time constraints associated with each time-dependent content item, and wherein a time constraint is a time period.

11. The computer-readable storage medium of claim 8, wherein the instructions further cause the processor to determine time constraints associated with each time-dependent content item, wherein a time constraint is a time period, and wherein the time period includes a range of predetermined times.

12. The computer-readable storage medium of claim 8, wherein the instructions further cause the processor to compare the time of day against time constraints associated with each time-dependent content item.

13. The computer-readable storage medium of claim 8, wherein the instructions further cause the processor to:
determine time constraints associated with each time-dependent content item; and
identify a match between the time of day and the time constraints.

14. The computer-readable storage medium of claim 8, wherein the instructions further cause the processor to:
determine time constraints associated with each time-dependent content item;
identify a match between the time of day and the time constraints; and
display the time-dependent content items that are associated with the time constraints that match the time of day.

15. A system comprising:
one or more processors; and
logic encoded in one or more tangible media for execution by the one or more processors, and when executed operable to:
open a content file, wherein the content file contains a plurality of time-dependent content items;
determine a time of day;
determine which time-dependent content items to display based on the time of day; and
display the time-dependent content items based on the time of day.

16. The system of claim 15, wherein the logic when executed is further operable to determine time constraints associated with each time-dependent content item.

17. The system of claim 15, wherein the logic when executed is further operable to determine time constraints associated with each time-dependent content item, and wherein a time constraint is a time period.

18. The system of claim 15, wherein the logic when executed is further operable to determine time constraints associated with each time-dependent content item, wherein a time constraint is a time period, and wherein the time period includes a range of predetermined times.

19. The system of claim 15, wherein the logic when executed is further operable to compare the time of day against time constraints associated with each time-dependent content item.

20. The system of claim 15, wherein the logic when executed is further operable to:
determine time constraints associated with each time-dependent content item; and
identify a match between the time of day and the time constraints.
